(19) United States
(12) Patent Application Publication
(10) Pub. No.: US 2025/0338309 A1
(43) Pub. Date: Oct. 30, 2025

(54) WIRELESS COMMUNICATION DEVICE, WIRELESS COMMUNICATION METHOD, AND WIRELESS COMMUNICATION SYSTEM

(71) Applicant: NIPPON TELEGRAPH AND TELEPHONE CORPORATION, Tokyo (JP)

(72) Inventors: Shoko SHINOHARA, Musashino-shi, Tokyo (JP); Yusuke ASAI, Musashino-shi, Tokyo (JP); Yoshitaka SHIMIZU, Musashino-shi, Tokyo (JP); Junichi IWATANI, Musashino-shi, Tokyo (JP); Tomoyuki YAMADA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/855,326

(22) PCT Filed: Apr. 14, 2022
(86) PCT No.: PCT/JP2022/017874

§ 371 Date: Oct. 9, 2024

(51) Int. Cl. H04W 74/0808; H04W 74/0833; H04W 88/04

(52) U.S. Cl. CPC H04W 74/0808; H04W 74/085; H04W 88/04

(57) ABSTRACT

The wireless communication device includes a plurality of wireless communication modules that uses channels interfering with each other. A repeater includes a control circuit that issues a command of a rule of a standby time to the wireless communication modules. The wireless communication modules belong to different communication groups, respectively, and perform communication processing for wirelessly communicating with a master device and a slave device, respectively, thereby relaying a packet therebetween. The communication processing includes processing of starting transmission of a packet in a case where, after an idle state is detected by carrier sensing, the idle state is maintained when the standby time elapses and processing of setting the standby time in accordance with the rule. A different rule is issued as a command to each of the plurality of wireless communication modules.

### TECHNICAL FIELD

The present disclosure relates to a wireless communication device, a wireless communication method, and a wireless communication system and relates to a wireless communication device, a wireless communication method, and a wireless communication system suitable for avoiding a signal collision caused by relay of wireless signals.

### BACKGROUND ART

In the field of wireless communication, a wireless signal repeater is used in some cases to expand a communication area. Typically, two wireless modules that communicate with terminals in different areas are provided in the repeater. Communication between the terminals belonging to the different areas can be established by causing the two wireless modules to transfer received packets in the repeater.

In order to use the two wireless modules in the same housing, it is necessary to avoid reception failure caused by interference. For example, when one module performs transmission processing while the other module performs reception processing, reception fails due to an influence of interference. Thus, it is necessary to avoid occurrence of such a situation.

Further, in a case where the terminal communicating with one wireless module and the terminal communicating with the other wireless module are hidden terminals, received signals collide with each other in the repeater. In this case, both the wireless modules may fail in transmission because the two wireless modules simultaneously perform transmission processing. In a case where the two wireless modules are used in the repeater, it is also necessary to avoid occurrence of such a situation.

As a method of avoiding the above situations, interference avoidance by frequency division has been proposed. For example, in a case where the two wireless modules use frequency channels well apart from each other, the above collision of wireless signals can be completely avoided.

Alternatively, interference avoidance by time division has been proposed. For example, there has been proposed a method of avoiding interference in an environment using the same frequency band by utilizing carrier sensing performed before transmission in an unlicensed band. Specifically, in a case where carrier sensing is introduced such that, while one of the wireless modules is receiving a signal having a certain level or higher, transmission from the other wireless module is stopped, it is possible to avoid, to some extent, interference caused by the other wireless module transmitting a signal while the one wireless module is receiving a signal.

### CITATION LIST

### Non Patent Literature

Non Patent Literature 1: IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications

### SUMMARY OF INVENTION

### Technical Problem

However, even if the above frequency division is performed, channels having sufficiently separate frequencies may not be prepared because the number of available frequency channels is small. In such a case, it is necessary to use overlapping channels or adjacent channels. In this case, even if each module performs carrier sensing on a channel used by the own module and use the channel, wireless signals may collide due to power leaking from its adjacent channel.

According to the rule of a wireless LAN (local area network), in transmission of wireless signals, carrier sensing is continuously performed and stood by for a time corresponding to the sum of an arbitration inter frame space (AIFS) time and a random backoff time after carrier sensing enters an idle state. Then, in a case where the idle state of the channel continues, transmission is started when a random backoff counter is completed. The “AIFS time” is a fixed time calculated as SIFS (short inter frame space) time+AIFSN (AIFS number) * slot time. The “random backoff time” is a value calculated as a randomly selected backoff counter * slot time.

FIG. 1 is a timing chart showing an operation in a case where two wireless communication module NIC (network interface card or network interface controller)-1 and NIC-2 included in the same housing complete counting at the same backoff counter value. In this case, end timings of random backoff overlap, and the NIC-1 and the NIC-2 simultaneously start transmission. As a result, transmission signals thereof interfere with each other, and terminals in both destinations fail in reception.

In the example of FIG. 1, if the two wireless communication modules NIC-1 and NIC-2 use different counter values, scheduled transmission timings are shifted, and one module starts transmission first. In this case, the other module determines that the channel is busy by using the carrier sensing function and stops transmission. As a result, a collision of wireless signals can be avoided.

FIG. 2 is a timing chart showing an operation in a case where a wireless communication master device belonging to one area and a wireless communication slave device belonging to the other area start transmission at the same timing. In the case of FIG. 2, even if the two devices that start transmission at the same timing are not included in the same housing, interference occurs in the repeater between signals to be received by the NIC-1 and the NIC-2, and both the devices may fail in reception.

In particular, in the field of communications, a rate of transmittable time may be limited. For example, in the 920 MHz band in Japan, a transmittable time per hour is limited to 360 seconds. In such an environment, retransmission due to reception failure directly affects a communication capacity, which is an important problem.

Further, a repeater that relays a packet received from a terminal in one area to a terminal in another area needs to perform transmission for transferring the received packet. Then, in a state of receiving a large number of wireless frames from a plurality of wireless communication slave devices, the repeater cannot transfer all packets due to a limitation of the transmission time, and thus transmission packets may be congested.

As described above, in the conventional repeater, transmission failure caused by interference and congestion of transmission packets may occur due to a collision of wireless signals. When both the transmission failure and the congestion occur, communication quality is greatly degraded.

The present disclosure has been made in view of the above problems, and a first object thereof is to provide a wireless communication device capable of shifting a transmission start timing so as to prevent simultaneous transmission in a plurality of communications using channels that interfere with each other.

A second object of the present disclosure is to provide a wireless communication method for shifting a transmission start timing so as to prevent simultaneous transmission in a plurality of communications using channels that interfere with each other.

A third object of the present disclosure is to provide a wireless communication system capable of shifting a transmission start timing so as to prevent simultaneous transmission in a plurality of communications using channels that interfere with each other.

### Solution to Problem

In order to achieve the above objects, a first aspect is desirably a wireless communication device including:
a plurality of wireless communication modules that uses channels interfering with each other; and
a control circuit that issues a command of a rule for setting a standby time to each of the plurality of wireless communication modules, in which:
each of the plurality of wireless communication modules belongs to a different communication group and performs communication processing of wirelessly communicating with a different communication device to relay a packet between a communication device belonging to one communication group and a communication device belonging to another communication group;
the communication processing includes
processing of starting transmission of a packet in a case where, after an idle state is detected by carrier sensing, the idle state is maintained when the standby time elapses, and
processing of setting the standby time in accordance with the rule; and
a different rule is issued as a command to each of the plurality of wireless communication modules.

A second aspect is desirably a wireless communication method using a wireless communication device including a plurality of wireless communication modules that uses channels interfering with each other and a plurality of communication devices that wirelessly communicates with the respective plurality of wireless communication modules, the wireless communication method including:
a step of issuing a command of a rule for setting a standby time to each of the plurality of wireless communication modules;
a step of causing each of the plurality of wireless communication modules to wirelessly communicate with a different communication device to form a different communication group;
a step of causing each of the plurality of wireless communication modules to relay a packet between a communication device belonging to one communication group and a communication device belonging to another communication group;
a step of causing each of the plurality of wireless communication modules to start transmission of a packet in a case where, after an idle state is detected by carrier sensing, the idle state is maintained when the standby time elapses;
a step of causing each of the plurality of wireless communication modules to set the standby time in accordance with the rule, in which
a different rule is issued as a command to each of the plurality of wireless communication modules.

A third aspect is desirably a wireless communication system including a wireless communication device including a plurality of wireless communication modules that uses channels interfering with each other and a plurality of communication devices that wirelessly communicates with the respective plurality of wireless communication modules, the wireless communication system including
a control circuit that issues a command of a rule for setting a standby time to each of the plurality of wireless communication modules, in which:
each of the plurality of wireless communication modules
wirelessly communicates with a different communication device to form a different communication group,
relays a packet between a communication device belonging to one communication group and a communication device belonging to another communication group,
starts transmission of a packet in a case where, after an idle state is detected by carrier sensing, the idle state is maintained when the standby time elapses, and
sets the standby time in accordance with the rule; and
a different rule is issued as a command to each of the plurality of wireless communication modules.

### Advantageous Effects of Invention

According to the first to third aspects, a scheduled time until transmission, which is counted in a case where a channel is in an idle state as a result of carrier sensing, can be shifted for each communication group. As a result, it is possible to prevent a plurality of communication groups using interfering channels from simultaneously starting transmission after performing carrier sensing. Therefore, according to the first to third aspects, it is possible to reduce a risk of interference of wireless signals and to improve communication throughput.

### BRIEF DESCRIPTION OF DRAWINGS

FIG. 1 shows a timing chart showing an operation in a case where two wireless communication modules NIC-1 and NIC-2 included in the same housing complete counting at the same backoff counter value;

FIG. 2 is a timing chart showing an operation in a case where a wireless communication master device belonging to one area and a wireless communication slave device belonging to the other area start transmission at the same timing;

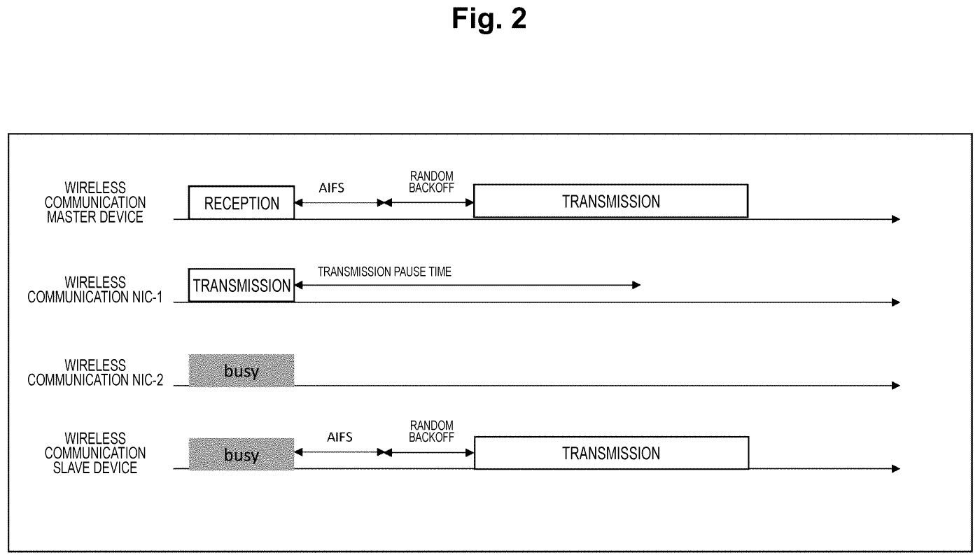

FIG. 3 is a block diagram showing a basic configuration of a wireless communication system in a first embodiment of the present disclosure;

FIG. 4 is a block diagram showing a detailed configuration of a wireless communication repeater shown in FIG. 3;

FIG. 5 shows two wireless groups formed in the wireless communication system of FIG. 3;

FIG. 6 shows a list of parameters such as AIFSN defined according to an access category (AC);

FIG. 7 is a flowchart showing a characteristic operation of a wireless communication repeater in a third embodiment of the present disclosure; and

FIG. 8 is a flowchart showing another example of the characteristic operation of the wireless communication repeater in the third embodiment of the present disclosure.

### DESCRIPTION OF EMBODIMENTS

### First Embodiment

### [Configuration of First Embodiment]

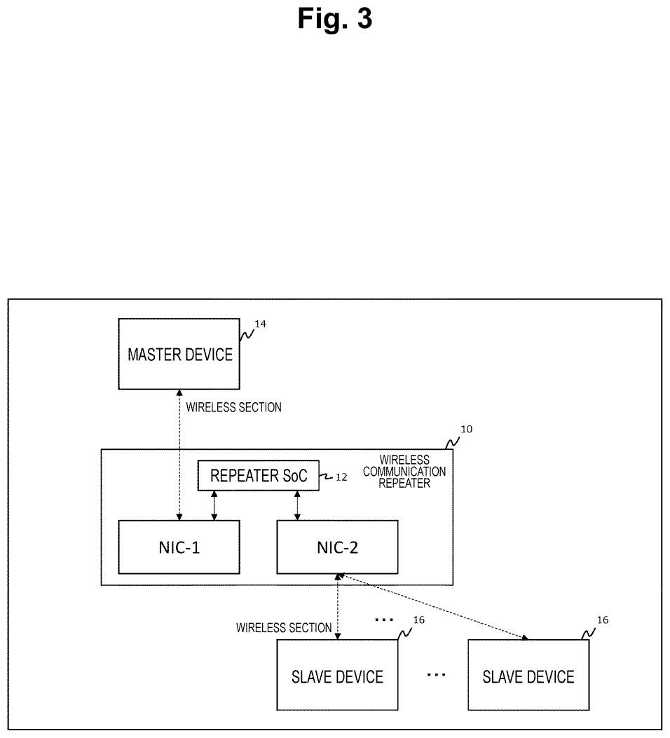

FIG. 3 is a block diagram showing a basic configuration of a wireless communication system in a first embodiment of the present disclosure. As shown in FIG. 3, the wireless communication system of the present embodiment includes a wireless communication repeater 10. The wireless communication repeater 10 includes a repeater SoC (system on chip) 12. The repeater SoC 12 is an integrated circuit for exchanging packets between a first wireless communication module NIC-1 (hereinafter, simply referred to as the NIC-1) and a second wireless communication module NIC-2 (hereinafter, simply referred to as the NIC-2). The repeater SoC 12 includes various elements necessary for implementing the above functions, such as a processor and a memory.

The NIC-1 is a wireless communication module for performing wireless communication with a master device 14 of wireless communication. The NIC-2 is a wireless communication module for performing wireless communication with a slave device 16 of wireless communication. The wireless communication system of the present embodiment includes the master device 14 and the slave device 16 and may include a plurality of slave devices 16. The master device 14 and the slave device 16 are separated to such an extent that the devices cannot perform direct communication, but can communicate with each other by interposing the wireless communication repeater 10.

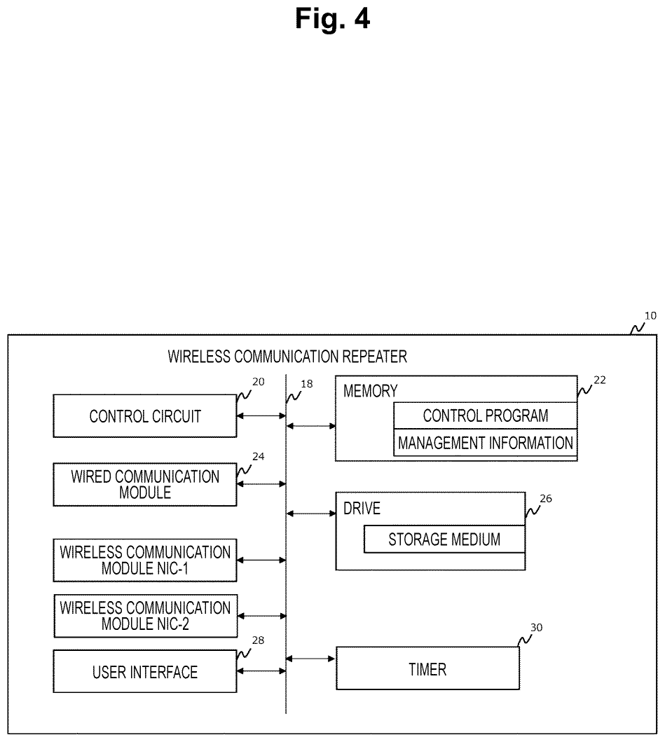

FIG. 4 is a block diagram showing a configuration of the wireless communication repeater 10 in more detail. As shown in FIG. 4, the wireless communication repeater 10 includes a communication bus 18. The communication bus 18 is connected to a control circuit 20 and a memory 22. The memory 22 stores a control program and management information. The control circuit 20 includes a processor and is implemented by the processor performing processing according to the above control program by using the above management information and the like. The control program can be provided via a computer-readable recording medium and can also be provided via a network.

The communication bus 18 is also connected to a wired communication module 24 and a drive circuit 26. The wireless communication repeater 10 can establish wired communication with an external device via the wired communication module 24. The drive circuit 26 includes a storage medium for storing various types of data.

The communication bus 18 is also connected to a user interface 28 and a timer 30. The user interface 28 is used for various input operations and the like to the wireless communication repeater 10. The timer 30 is used for, for example, counting a standby time at the time of carrier sensing.

The communication bus 18 is further connected to the NIC-1 and the NIC-2 also shown in FIG. 3. As described above, the NIC-1 is a wireless communication module for establishing wireless communication between the wireless communication repeater 10 and the master device 14. Meanwhile, the NIC-2 is a wireless communication module for establishing wireless communication between the wireless communication repeater 10 and the slave device 16.

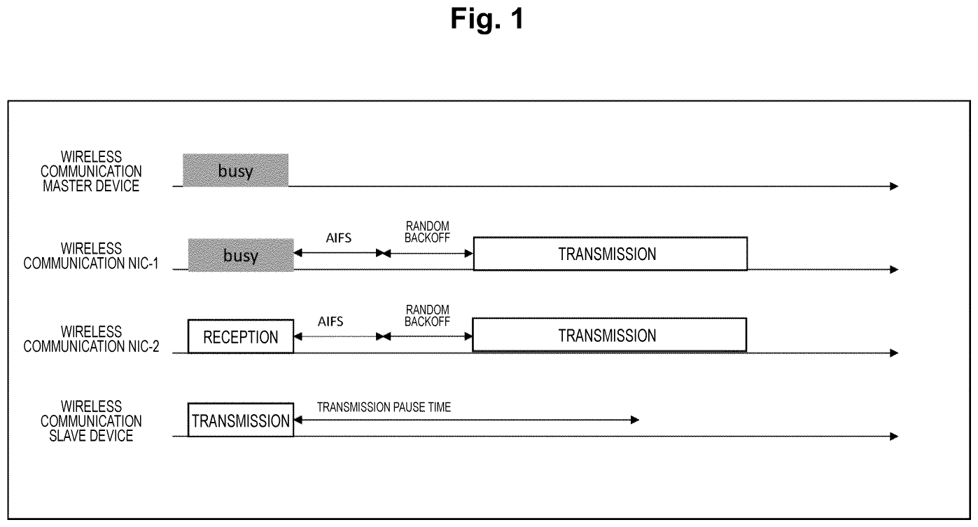

When starting wireless transmission, the NIC-1 and the NIC-2 perform carrier sensing in accordance with DCF (distributed coordination function) of IEEE 802.11 that is a standard regarding access control. Specifically, the NIC-1 and the NIC-2 continue carrier sensing until a standby time corresponding to the sum of an AIFS time and a random backoff time elapses after carrier sensing enters the idle state, and, in a case where the idle state is maintained when the standby time has elapsed, the NIC-1 and the NIC-2 start transmitting packets (see FIG. 1).

Here, according to the above DCF, priority of a packet to be transmitted is reflected in the random backoff time. Specifically, the NIC-1 and the NIC-2 each randomly select one of natural numbers falling within a range of 0 to CWmin (Contention Window Minimum) as a backoff value in accordance with the priority of a packet to be transmitted. Note that an upper limit of the backoff value is increased to CWmax (Contention Window Maximum) depending on the number of times of retransmission caused by communication failure.

### [Feature of First Embodiment]

The NIC-1 and the NIC-2 randomly select a backoff value. In a case where both the NICs freely select the backoff value without any limitation, the values match with a certain probability. Then, when the backoff values of both the NICs match, transmission from the NIC-1 and transmission from the NIC-2 collide with each other as described with reference to FIG. 1.

In the present embodiment, in order to avoid such a communication collision, in a case where there is a plurality of communication groups using interfering channels, a population of random values is set for each group. That is, a population from which one communication group selects a random value and a population from which another communication group selects a random value are set so as not to include overlapping values.

More specifically, in the present embodiment, the NIC-1 and the NIC-2 communicate by using interfering channels in the same housing. Therefore, here, it is considered that there are two communication groups using interfering channels. Then, the NIC-1 and the NIC-2 each are caused to randomly select the backoff value from a population of even numbers or odd numbers, instead of a population of natural numbers.

Here, for example, the NIC-1 is caused to select an even backoff value, and the NIC-2 is caused to select an odd backoff value. Such a setting can be implemented by giving a command from the control circuit 20 to both the NIC-1 and the NIC-2 having a function of selecting a random backoff value. Such a limitation makes it possible to reliably prevent the backoff value selected by the NIC-1 and the backoff value selected by the NIC-2 from being the same.

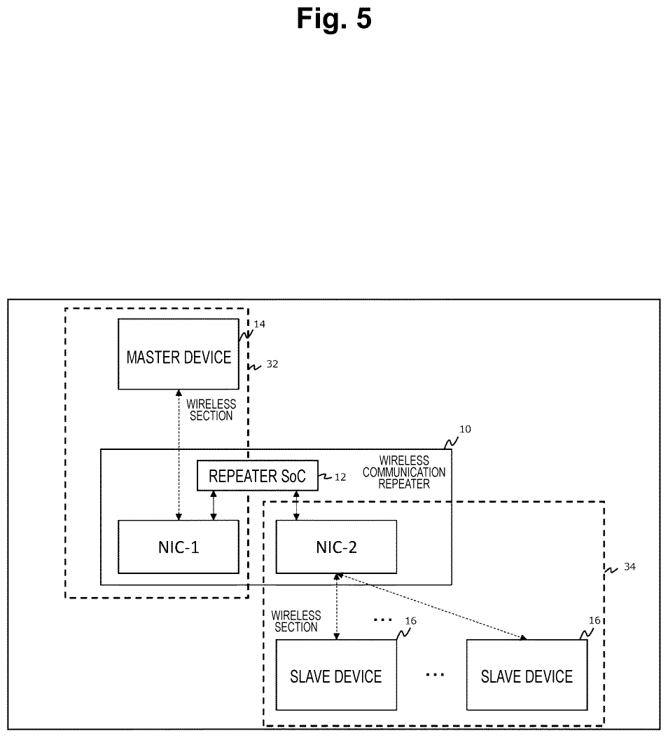

FIG. 5 shows two communication groups 32 and 34 formed in the wireless communication system of the present embodiment. In the present embodiment, the limitation on the backoff values is also imposed on the master device 14 that communicates with the NIC-1 and the slave device 16 that communicates with the NIC-2. That is, the master device 14, as well as the NIC-1, is required to select the backoff value from the population of even numbers. Meanwhile, the NIC-2 is required to select the backoff value from the population of odd numbers.

Each of such requirements is issued from the NIC-1 or the NIC-2 to the master device 14 or the slave device 16 serving as a communication partner in response to a command from the control circuit 20. Communication devices used in the present embodiment, such as the master device 14 and the slave device 16, are assumed to have a function that can appropriately set a parameter of a standby time caused by carrier sensing in response to the requirements.

As described above, in the present embodiment, the communication group 32 including the NIC-1 and the master device 14 is required to have a randomly selected even value as the backoff value. Meanwhile, the communication group 34 including the NIC-2 and the slave device 16 is required to have a randomly selected odd value as the backoff value. In a case where each of the communication groups 32 and 34 selects a random value according to the above rule, a collision of wireless signals between the groups can be reliably avoided.

### [Modification Example of First Embodiment]

In the above first embodiment, the number of communication groups using interfering channels is two. However, three or more communication groups may establish wireless communication in a mesh shape as a wireless communication environment. The present disclosure can be applied to such an environment.

That is, the number of communication groups using interfering channels is assumed to be n (n is a natural number of two or more) by generally expanding the disclosure of the first embodiment. In this case, in the k-th communication group, an arithmetic progression represented by B=m×n+k is obtained as a population of random values. Here, k is any natural number of 1 to n, and m is a natural number of 0 or more.

For example, in a case of the number of communication groups n=3, the communication groups are as follows:
Group of k=1: the population is an arithmetic progression 1, 4, 7, 10, 13, . . . ;
Group of k=2: the population is an arithmetic progression 2, 5, 8, 11, 14, . . . ; and
Group of k=3: the population is an arithmetic progression 3, 6, 9, 12, 15, . . . .

A function of the above generalized modification example can be implemented by causing a communication module or communication terminal belonging to each communication group to select a random backoff value in accordance with a limitation imposed on each communication group. When the function is implemented, the standby times of all the communication groups reliably have different values. This makes it possible to reliably avoid a collision of wireless signals in all the communication groups.

### Second Embodiment

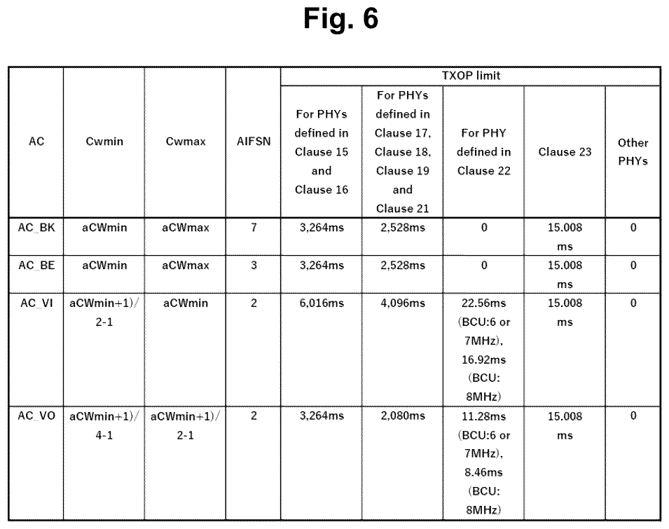

Next, a second embodiment of the present disclosure will be described with reference to FIG. 6 together with FIGS. 3 to 5.

A wireless communication system of the present embodiment can be implemented by the hardware configuration shown in FIGS. 3 and 4 as in the first embodiment. Also in the present embodiment, as shown in FIG. 5, the standby times of the communication groups 32 and 34 are set so as not to have the same value.

As described above, according to the DCF of IEEE 802.11, the sum of the AIFS time and the random backoff time is set as the standby time at the time of carrier sensing. In the above first embodiment, a collision of wireless signals is avoided by preventing overlapping of the random backoff times between the communication groups. In the present embodiment, a similar function is implemented by preventing overlapping of the AIFS times.

The AIFS time is calculated as “SIFS time+AIFSN * slot time” as described above. The AIFSN is a parameter determined according to an access category of communication or the like. In the present embodiment, more specifically, a value of the AIFSN is set to be different for each communication group, thereby avoiding the same standby time.

FIG. 6 shows a list of parameters such as the AIFSN defined according to the access category (AC). Values in the list are general rules defined by IEEE. For example, in a case where the priority of a packet is AC_BE (access category best effort), the AIFSN is normally 3 as shown in FIG. 6. The NIC-1 and the NIC-2 relay the same communication, and thus both the NICs are in the same access category. Therefore, in the configuration of the present embodiment, both the NICs normally have the same AIFSN value.

Meanwhile, in the present embodiment, for example, the AIFSNs of both the communication groups are set to different values such that the AIFSN of the communication group 32 including the NIC-1 and the master device 14 is set to 3, and the AIFSN of the communication group 34 including the NIC-2 and the slave device 16 is set to 7. Although depending on the length of the random backoff time, the standby time tends to be shorter as the AIFSN is smaller. Therefore, under the above setting, the standby time of the communication group 32 is likely to be shorter than the standby time of the communication group 34.

Specifically, assuming that the CWmin is 15, the backoff value is selected within the range of 0 to 15. Although detailed calculation is omitted, in this case, a probability that the communication group 32 having the AIFSN of 3 starts transmission before the communication group 34 is approximately 70%. Then, a probability that the two communication groups 32 and 34 simultaneously start transmission is reduced from 6.25% to 4.78, as compared with a case where the AIFSNs have the same value.

As described above, in the present embodiment, the AIFSNs are set to different values in a plurality of communication groups that perform the same communication. As a result, in the present embodiment, it is possible to reduce a probability that a plurality of communication groups simultaneously start transmission, as compared with a case where the AIFSNs have the same value. Therefore, according to the wireless communication system of the present embodiment, as in the first embodiment, it is possible to suppress a signal collision between communication groups and to increase communication throughput as a whole.

### [Modification Example of Second Embodiment]

Depending on a wireless communication standard, each wireless device may be required to have a pause time after the end of transmission. For example, in the 920 MHz band in Japan, the pause time of 2 msec or more may be required after transmission depending on a condition on a transmission side. In such a case, although a more pause time than necessary is set, it is considered that a different pause time is set for each communication group. For example, it is considered that the pause time of the communication group 32 is set to 2 msec, whereas the pause time of the communication group 34 is set to 2.5 msec. As described above, in a case where the pause time is set to a different value for each communication group, a start timing of the standby time is shifted. Thus, a possibility of a collision between the communication groups can be greatly reduced. Note that the method of setting the pause times to different values may be combined with the method of setting the AIFSNs to different values or may be separated from the method and be used alone.

Note that the above second embodiment shows a case of two communication groups, but the present disclosure is not limited thereto. As described in the modification example of the first embodiment, in a case where three or more communication groups establish communication in a mesh shape, parameters such as the AIFSN and the pause time are set to different values for each group, thereby obtaining an effect similar to the above.

### Third Embodiment

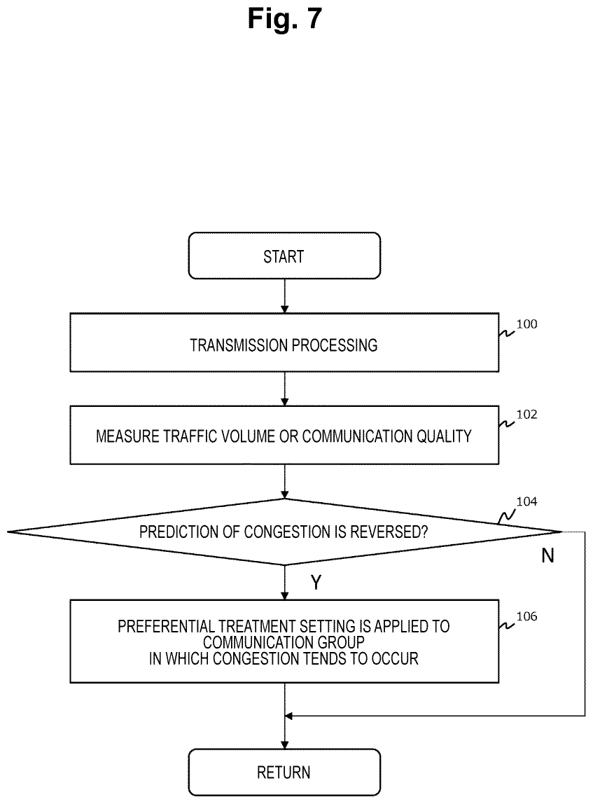

Next, a third embodiment of the present disclosure will be described with reference to FIG. 7 together with FIGS. 3 to 5.

A wireless communication system of the present embodiment can be implemented by the hardware configuration shown in FIGS. 3 and 4 as in the first embodiment. Also in the present embodiment, as shown in FIG. 5, the standby times of the communication groups 32 and 34 are set so as not to have the same value.

In the above second embodiment, the AIFSN is set to a different value for each communication group, thereby reducing a probability that the standby times simultaneously end. At this time, as described above, transmission starts earlier in the communication group whose AIFSN is set to a small value than in the communication group whose AIFSN is set to a large value with a high probability. That is, the communication group whose AIFSN is set to a small value is preferentially treated regarding acquisition of a transmission right.

Similar preferential treatment also occurs depending on the length of the pause time described in the modification example of the second embodiment. Specifically, communication starts earlier in the communication group whose pause time is set to 2 msec than in the communication group whose pause time is set to 2.5 msec with a high probability. Further, in a case where the CWmin defining the upper limit of the random backoff value is set to a different value for each communication group, a group having a small CWmin is preferentially treated.

In the present embodiment, a plurality of slave devices 16 is wirelessly connected to the NIC-2. Therefore, the NIC-2 transfers packets uploaded from the plurality of slave devices 16 to the NIC-1. Then, the NIC-1 needs to upload all the packets to the master device 14 via a wireless section. In such a configuration, packet congestion tends to occur in the NIC-1. Therefore, in a case where a preferential treatment setting is applied to the communication group 32 including the NIC-1, occurrence of congestion can be suppressed.

However, when the preferential treatment setting of the communication group 32 permanently continues, packet congestion may occur in the communication group 34. Therefore, in the present embodiment, a setting parameter of the standby time is made different for each communication group by using the method described in the first or second embodiment, and, in addition, the setting of preferentially treating the communication group 32 and the setting of preferentially treating the communication group 34 are alternately switched.

FIG. 7 is a flowchart showing a flow of a routine performed in the control circuit 20 of the wireless communication repeater 10 to implement the above functions. The routine is repeatedly performed after communication via the wireless communication repeater 10 is started.

In the routine of FIG. 7, first, processing necessary for transmission of wireless communication is performed (step 100). Specifically, processing for causing the repeater SoC 12 to relay a packet between the NIC-1 and the NIC-2 is performed. In a case where it is necessary to perform initial setting, in step 100, parameters of the standby time are set to the two communication groups 32 and 34 such that a preferential treatment setting is applied to the communication group 32.

Next, processing for measuring a traffic volume or communication quality is performed on each of the communication groups 32 and 34 (step 102).

Next, based on the measurement result, it is determined whether or not the communication group in which congestion is predicted is reversed (step 104). In the initial setting, it is determined that congestion tends to occur in the communication group 32 including the NIC-1. In a case where the initial setting is maintained, it is determined whether or not the group in which occurrence of congestion is predicted has been changed from the communication group 32 to the communication group 34. Meanwhile, in a case where the prediction has already been switched, it is determined whether or not the group in which occurrence of congestion is predicted has been changed from the communication group 34 to the communication group 32.

In a case where it is determined in step 104 that the prediction has not been reversed, the current routine ends as it is. In this case, the preferential treatment setting is maintained as it is. Meanwhile, in a case where it is determined that the prediction has been reversed, the parameter setting of the standby times is reversed such that the preferential treatment setting is applied to the communication group in which congestion tends to occur (step 106).

According to the above processing, it is possible to appropriately apply the preferential treatment setting to the communication group in which occurrence of congestion is predicted while maintaining a state in which the probability that the standby times simultaneously end is low. Therefore, according to the wireless communication system of the present embodiment, it is possible to stably maintain high throughput without causing packet congestion.

### [Modification Example of Third Embodiment]

In the above third embodiment, the communication group to which the preferential treatment setting is applied is switched when prediction of congestion is reversed. However, a switching timing thereof is not limited thereto. That is, in order to secure stability of control and to give a hysteresis characteristic to the switching of the preferential treatment setting, the above switching may be performed when a difference between numerical values regarding prediction of congestion exceeds a predetermined threshold.

Further, in the above third embodiment, the traffic volume and the communication quality are measured for each communication group, and, based on the measurement result, a target of the preferential treatment setting is switched. However, the present disclosure is not limited thereto. For example, measurement of the communication quality and the like may be omitted, and a target to which the preferential treatment setting is applied may be switched between the communication group 32 and the communication group 34 at certain time intervals.

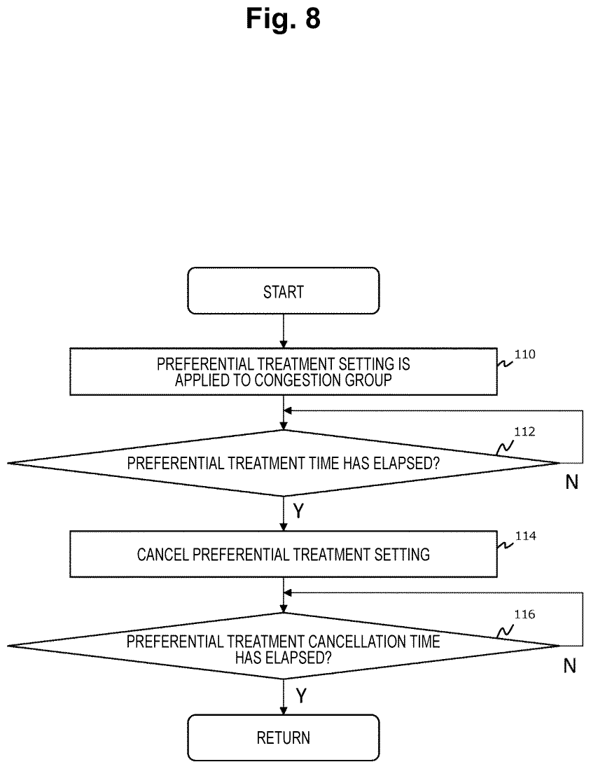

FIG. 8 is a flowchart showing a flow of a routine performed in the control circuit 20 of the wireless communication repeater 10 in a case where a target to which the preferential treatment setting is applied is switched at certain time intervals. In the routine, first, the preferential treatment setting is applied to the communication group 32 in which occurrence of congestion is structurally predicted (step 110).

Then, when a certain “preferential treatment time” has elapsed (step 112), the above preferential treatment setting is canceled. Then, the setting is switched to a setting in which the communication group 34 is preferentially treated in accordance with the cancellation (step 114).

Further, when a “preferential treatment cancellation time” in which the communication group 34 is to be preferentially treated has elapsed (step 116), the current routine ends. Then, step 110 is performed again, and the state in which the communication group 32 is preferentially treated is restored. At this time, in a case where the “preferential treatment time” in which the communication group 32 is preferentially treated is set longer than the “preferential treatment cancellation time”, it is possible to suppress occurrence of congestion in the wireless communication system in a long-term and stable manner while reducing a control load, as compared with a case of using the routine of FIG. 7.

Note that the above third embodiment shows a case of two communication groups, but the present disclosure is not limited thereto. As described in the modification example of the first or second embodiment, in a case where three or more communication groups establish communication in a mesh shape, targets to which the preferential treatment setting is applied are sequentially switched, thereby obtaining an effect similar to the above.

In the above first embodiment, the probability that the standby times simultaneously end is reduced by using different populations at the time of selecting a random backoff time. In the second embodiment, a similar effect is achieved by setting the AIFSNs or the pause times to different values. That is, the present disclosure provides a technique of reducing the frequency of collisions of wireless signals in a plurality of communication groups by changing a rule for setting the standby time.

### REFERENCE SIGNS LIST

10 Wireless communication repeater
12 Repeater SoC (system on chip)
14 Master device
16 Slave device
20 Control circuit
22 Memory
NIC-1, NIC-2 Wireless communication module (network interface card or network interface controller)

1. A wireless communication device comprising:
a plurality of wireless communication modules that uses channels interfering with each other; and
a control circuit that issues a command of a rule for setting a standby time to each of the plurality of wireless communication modules, wherein:
each of the plurality of wireless communication modules is configured to belong to a different communication group and perform wireless communication with a different communication device to relay a packet between a communication device belonging to one communication group and a communication device belonging to another communication group;
the wireless communication includes:
starting transmission of a packet in a case where, after an idle state is detected by carrier sensing, the idle state is maintained when the standby time elapses; and
setting the standby time in accordance with the rule, and wherein
a different rule is issued as the command to each of the plurality of wireless communication modules.

2. The wireless communication device according to claim 1, wherein:
the setting the standby time includes:
selecting a random backoff time by randomly selecting a numerical value from a population; and
setting the standby time so as to include the random backoff time, wherein
the rule includes specification of the population, and
the control circuit issues the command of the rule such that a command of a different population is issued to each of the plurality of wireless communication modules.

3. The wireless communication device according to claim 1, wherein
the setting the standby time includes:
selecting a random backoff time by randomly selecting a numerical value;
calculating a fixed time based on a parameter; and
setting the standby time so as to include the random backoff time and the fixed time, and wherein
the rule includes specification of the parameter, and
the control circuit issues the command of the rule such that a command of a different parameter is issued to each of the plurality of wireless communication modules.

4. The wireless communication device according to claim 3, wherein:
the fixed time is an AIFS time calculated as SIFS time+AIFSN * slot time; and
the parameter is the AIFSN.

5. The wireless communication device according to claim 3, wherein:
the fixed time includes a pause time provided after end of transmission; and
the parameter is the pause time.

6. The wireless communication device according to claim 1, wherein
the control circuit is configured to sequentially switch a preferential treatment setting target having a shorter standby time than another wireless communication module between the plurality of wireless communication modules.

7. A wireless communication method using a wireless communication device including a plurality of wireless communication modules that uses channels interfering with each other and a plurality of communication devices that wirelessly communicates with the respective plurality of wireless communication modules, the wireless communication method including:
issuing a command of a rule for setting a standby time to each of the plurality of wireless communication modules;
causing each of the plurality of wireless communication modules to wirelessly communicate with a different communication device to form a different communication group;
causing each of the plurality of wireless communication modules to relay a packet between a communication device belonging to one communication group and a communication device belonging to another communication group;
causing each of the plurality of wireless communication modules to start transmission of a packet in a case where, after an idle state is detected by carrier sensing, the idle state is maintained when the standby time elapses;
causing each of the plurality of wireless communication modules to set the standby time in accordance with the rule, wherein
a different rule is issued as a command to each of the plurality of wireless communication modules.

8. A wireless communication system including a wireless communication device including a plurality of wireless communication modules that uses channels interfering with each other and a plurality of communication devices that wirelessly communicates with the respective plurality of wireless communication modules, the wireless communication system comprising
a control circuit that issues a command of a rule for setting a standby time to each of the plurality of wireless communication modules, wherein
each of the plurality of wireless communication modules is configured to:
wirelessly communicate with a different communication device to form a different communication group;
relay a packet between a communication device belonging to one communication group and a communication device belonging to another communication group;
start transmission of a packet in a case where, after an idle state is detected by carrier sensing, the idle state is maintained when the standby time elapses; and
set the standby time in accordance with the rule, and wherein
a different rule is issued as a command to each of the plurality of wireless communication modules.
